(19) United States
(12) Patent Application Publication
(10) Pub. No.: US 2013/0225675 A1
(43) Pub. Date: Aug. 29, 2013

(54) BACTERIAL CONTROL OF WATER BASED FLUIDS DURING SUBSURFACE INJECTION AND SUBSEQUENT RESIDENCE TIME IN THE SUBTERRANEAN FORMATION

(71) Applicants: Gregory Kubala, Houston, TX (US); Iain Cooper, Sugar Land, TX (US); Shawn McCleskey Rimassa, Katy, TX (US); Robert Seth Hartshorne, Cambridge (GB)

(72) Inventors: Gregory Kubala, Houston, TX (US); Iain Cooper, Sugar Land, TX (US); Shawn McCleskey Rimassa, Katy, TX (US); Robert Seth Hartshorne, Cambridge (GB)

(73) Assignee: SCHLUMBERGER TECHNOLOGY CORPORATION, Sugar Land, TX (US)

(21) Appl. No.: 13/807,895

(22) PCT Filed: Jun. 29, 2011
(86) PCT No.: PCT/US2011/042298

§ 371 Date: May 15, 2013

Related U.S. Application Data
(60) Provisional application No. 61/359,993, filed on Jun. 30, 2010.

(51) Int. Cl. A01N 43/08; C09K 8/60; E21B 37/00

(52) U.S. Cl. CPC A01N 43/08; E21B 37/00; C09K 8/605
USPC 514/473; 166/308.1; 507/261; 507/239; 507/254; 507/245; 507/90; 514/680

(57) ABSTRACT

Apparatus and methods to prevent the proliferation of undesired life forms in a subterranean formation, comprising forming a fluid comprising an inhibitor; and introducing the inhibitor to a surface in the formation. Apparatus and methods to prevent the proliferation of undesired life forms along a surface of tubular or equipment for use in the oil field services industry, comprising forming a coating comprising an inhibitor; and introducing the coating to a surface of the tubular or equipment. Apparatus and methods to prevent the proliferation of undesired life forms along a surface of tubular or equipment for use in the oil field services industry, comprising forming a material comprising an inhibitor; and embedding the material into a surface of the tubular or equipment.

### BACKGROUND

The statements made in this section merely provide information related to the present disclosure and may not constitute prior art and may describe some embodiments illustrating the invention.

Water, as used in the oil field services industry, may contain a variety of undesirable life forms that may exist in the water or along surfaces of equipment or subterranean formations. Bacteria can be classified or categorized in a variety of ways. All of them have aspects that are generally undesirable in the oil and gas industry. Examples of bacteria include sulfate reducing bacteria (SRB), acid forming bacteria (AFB), and general heterotrophic bacteria (GHB). Bacteria may be sessile or slime forming bacteria (SFB), or they may be planktonic bacteria. Sulphate reducing bacteria (SRBs), denitrifying bacteria, ‘slime forming bacteria’, iron-oxidising bacteria and miscellaneous organisms such as yeasts, moulds and protozoa may foul a variety of oil field service applications including fracturing, drilling, controlling sand, cementing, injecting a well, or using offshore equipment such as seismic streamers. Additional undesirable agents may proliferate in the water including fungus, algae, mollusks, or other life forms. Surfaces of equipment or subterranean formations exposed to marine environments or brine based systems may also suffer from the prolific reproduction of undesired life forms including barnacles, marine algae “slime,” and mollusks.

For example, hydraulic fracturing processes often collect the flowback and produced water and use the water for subsequent fracture treatments. Produced water is a perfect environment for SRB and acid forming bacteria due to its anaerobic nature (<2 ppm oxygen content) and high nutrient content (organics, free iron, etc.). Reuse of water (often a mixture of produced water and seawater) introduces enough oxygen and nutrients (e.g. sulphate ions, organic carbon and ammoniacal nitrogen) through regular pumping operations to allow aerobic bacteria to grow.

The growth of bacteria, including sessile bacteria and SRBs will not only lead to health and safety concerns due to increased sour gas or hydrogen sulfide (H₂S) production but also to a slow souring of the reservoir and even formation damage. This also increases operation expenses due to added corrosion (H₂S pitting, stress cracking etc) in surface and subsurface tubulars and related prevention expenses. Other challenges in production can be related to AFBs (pitting) and SFBs (emulsion-like materials may form). In fact, bacteria may cause damage anywhere, from the tubing to the gravel pack, to the formation pore space. Bacteria are most commonly a problem in injection wells. In any event, the rapid reproduction results in a combination of slimes and assorted amorphous mess that blocks production.

Also, a few examples of particulate generation produced by bacterial corrosion include the oxidation of soluble iron (ferrous (Fe²⁺)) to (ferric, Fe³⁺) iron resulting in the generation of iron sulfide and iron carbonate in the presence of hydrogen sulfide and carbonate respectively. Further iron oxidation products in combination with hydroxyl ions produce precipitated iron hydroxides (e.g. Fe(OH)₃) or rust. Along the formation face, the problems include microbiological corrosion of a well's tubular and screens, biomass plugging in injection wells and in the formation, and H₂S production deep in the formation, leading to microbial reservoir souring. Bacterial control is also important in the prevention formation damage during the subsurface injection of water based fluids.

### SUMMARY

Embodiments of the invention relate to apparatus and methods to prevent the proliferation of undesired life forms in a subterranean formation, comprising forming a fluid comprising an inhibitor and introducing the inhibitor to a surface in the formation. Embodiments of the invention relate to apparatus and methods to prevent the proliferation of undesired life forms along a surface of tubular or equipment for use in the oil field services industry, comprising forming a coating comprising an inhibitor and introducing the coating to a surface of the tubular or equipment. Embodiments of the invention relate to apparatus and methods to prevent the proliferation of undesired life forms along a surface of tubular or equipment for use in the oil field services industry, comprising forming a material comprising an inhibitor; and embedding the material into a surface of the tubular or equipment.

### FIGURES

For a more complete understanding of the present invention, and the advantages thereof, reference is now made to the following descriptions taken in conjunction with the accompanying figures, in which:

FIG. 1 is photograph series that compares the experimental results of testing the effectiveness of biocide compositions.

### DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The statements made herein merely provide information related to the present disclosure and may not constitute prior art, and may describe some embodiments illustrating the invention.

### Chemicals for the Control of Undesired Life Forms

Various different chemical methods have been applied to prevent bacteria growth and reduce operational expenses related to corrosion prevention, remediation of corrosion effects, and remediation of emulsion-like produced fluids. Chemicals for control of bacteria in oilfield applications can be divided into two main classes: biocides (oxidizing and non-oxidising/organic) and biostats (control ‘biocides’ or metabolic inhibitors). Biocides kill bacteria at normal use concentrations; biostats do not kill bacteria but interfere with their metabolism or ‘activity’.

### Biocides, Inhibitors, Biostats, etc.

Common oxidizing biocides include hypochlorite and hypobromite salts, chlorine dioxide and hydrogen peroxide. This category of biocides oxidize and/or hydrolyse protein/polysaccharide groups in (or on the outer surface of) the microorganism resulting in a loss of normal enzyme activity and cell death.

Non-oxidizing organic biocides function primarily by altering the permeability of the cell walls of microorganisms and interfering with their metabolic processes. Examples include aldehydes (e.g. glutaraldehyde), quaternary phosphonium compounds (e.g. tetrakishydroxymethyl phosphonium sulfate (THPS)), cationic polymers and alky-, di- and tri-amines, isothiazolones and thiones (e.g. 3,5-dimethyl-1,3,5-thiadiazinane-2-thione) and phenolics and long chain (>C12) quaternary ammonium compounds (e.g. n-alkyl dimethylbenzalkonium chloride). Quaternary amine compounds are generally used in low-total dissolved solids waters. Generally these compound function best alkaline pH levels. They have low reactivity with other chemicals and are inactivated in brines.

Despite the treatment of water with these biocides, frequent post-fracture treatment reservoirs souring has been reported. Apparently, these biocides do not always completely kill (or sterilize) all the bacteria (i.e., SRB) in the water and residual bacterium re-grow and multiply in the reservoir with time. The re-growth of SRB under reservoir conditions may lead to reservoir souring. Also, these conventional chemicals tend to kill bacteria and by this very behavior cause them to be harsh. These chemicals stretch health and safety resources and have high costs. They also tend to be short lived in effectiveness.

The second class of chemical control method are biostats. Biostats don't generally kill bacteria but interfere with internal metabolic processes. Examples of biostats that are not biocides include anthraquinone, nitrite and nitrate ions and selenate, molybdate, and tungstate ions. The above molecules are generally added to promote bacterial competition, i.e. to enable nitrate reducing bacteria to outcompete particularly problematic microorganisms such as sulphate reducing bacteria.

A family of biostats that work well to prevent or ameliorate biofilms are referred to as anti-biofilm compounds. Anti-biofilm compounds interfere with signaling systems employed by bacteria. Bacteria depend on signaling systems to colonize surfaces, to form biofilms, and to maintain these biofilms once formed. This technology does not kill microrganisms, but “jams” signaling to stop bacterial colonisation. Thus, bacterial resistance and non-target environmental impacts are avoided. Anti-biofilm compounds are historically used to reduce the microrganisms' ability to form biofilms on surfaces including contact lenses, medical devices, animate surfaces (such as lungs, skin and teeth), pipes, ship hulls, and membranes.

Compounds that act as anti-biofilm inhibitors include fully substituted butenolides, also known as fully alkylated butenolides, fully substituted 2-furanones, or fully alkylated 2-furanones.

In addition to the methods of microrganism control disclosed above, there are several additional chemical treatments that can be used in combination with biocides and/or biostats to limit the rate of microorganism reproduction and growth.

### Environmental Modification Agents

Several agents may be introduced to a fluid or a surface to prevent the proliferation of life forms. pH modification agents to adjust pH or salts to influence salinity may be used. Some embodiments may benefit from the presence of an oxygen scavenger to prevent respiration or other metabolic processes. Some embodiments may benefit from the introduction of competitive, but less destructive species of life form. Temperature or pressure may be adjusted, if possible. Some agents may be selected to starve or otherwise change the availability of food for the life form.

### Surfactants

Water wetting surfactants may also be selected for use in combination with biocide, biostats, and/or inhibitors. Examples of appropriate surfactants include cationic, anionic, nonionic, and amphoteric surfactants. Specific surfactants that may be desirable for some applications include alkyl amines, alcohol ethoxysulfate salt, tridecyl ether sulfate salt, ethoxylated alcohol and/or decyl-dimethyl amine oxide. For example, a combination of a fully alkylated butenolide inhibor and ethoxylated alcohol or decyl-dimethyl amine oxide surfactant may be desirable in some applications.

### Polymers

Some fluids may benefit from the reduced life form population of some embodiments of the invention. The fluids as described herein may also benefit from the presence of other additives to tailor properties of the fluid such as friction reducers, viscosifiers, crosslinkers, emulsions, stabilizers, scale inhibitors, solid particles such as proppant or fibers, or gases such as nitrogen may be included in the fluid. The medium may include viscosity modifying agents such as guar gum, hydroxyproplyguar, hydroxyelthylcellulose, xanthan, or carboxymethylhydroxypropylguar, diutan, chitosan, polyacrylamide, or other polymers or additives used to modify viscosity for use in the field. In some embodiments, the medium may contain viscosity modifying agents that comprise viscoelastic surfactant. Viscoelastic surfactants include cationic, anionic, nonionic, mixed, zwitterionic and amphoteric surfactants, especially betaine zwitterionic viscoelastic surfactant fluid systems or amidoamine oxide viscoelastic surfactant fluid systems.

### Practical Considerations

Some embodiments may benefit from using a combination of several agents. For example, some embodiments may benefit from using a combination of biocide and inhibitor/biostat. Some embodiments may benefit from the specific combination of glutaraldehyde and a surfactant such as an ethoxylated alcohol or decyl-dimethyl amine oxide and an inhibitor such as a fully alkylated butenolide.

Some embodiments may benefit from using a composition comprising a biocide and/or biostat in a coating or be encapsulated within a capsule/matrix. Some embodiments may benefit from embedding the material in a surface. Some embodiments may benefit from using it as a fluid additive.

The inhibitor/biostat, alone or in combination with a biocide and/or a surfactant may be used in a variety of fluids.

### Hydraulic Fracturing

Hydraulic fracturing fluids may specifically benefit from a combination of biocide and inhibitor/biostat such as glutaraldehyde and a fully alkylated butenolide. The fluids for use in hydraulic fracturing may especially benefit from the presence of a surfactant, biocide, inhibitor, and an oxygen scavenger. The oxygen scavenger can be thiosulfate or ammonium bisulfate. The surfactant can be an ethoxylated alcohol or decyl-dimethyl amine oxide. The hydraulic fracturing fluid may also contain a scale inhibitor such as a phosphate ester, phosphino-acrylate, polyphosphate, phosphonate, or a phosphate free scale inhibitor such as a polysaccharide-polyacrylamide hybrid polymer or a combination thereof Additionally, the medium would contain a viscosifier such as a polyacrylamide emulsion.

### Marine Environments

Fluids for use in marine environments may specifically benefit from a combination of biocide and inhibitor such as glutaraldehyde and a fully alkylated butenolide. The fluids for use in marine environments may especially benefit from the presence of a metabolic inhibitor such as calcium nitrate, a biocide such as 2,2-dibromo-3-nitrilopropionamide, and an inhibitor such as a fully alkylated butenolide.

Surfaces of equipment for use in marine environments may benefit from embodiments of this invention. For example, offshore seismic streamers, subsea equipment such as those with control valves, sensors, and other stationary or movable parts may benefit from a coating or material embedded in the surface.

### Injectors

Injector fluids may specifically benefit from a combination of biocide and inhibitor such as tetrakishhydroxymethyl phosphonium sulfate (THPS), and a fully alkylated butenolide. The fluids for use in injectors both offshore and on land may especially benefit from the presence of glutaraldehyde, and a fully alkylated butenolide.

### Advantages

The present methods are discussed herein with specific reference to the embodiment of water fracturing fluid, fracturing pit fluid, or onshore or offshore water injector fluid, but it is also suitable for methods as gravel packing, or for fracturing and gravel packing in one operation (called, for example frac and pack, frac-n-pack, frac-pack, StimPac treatments, or other names), which are also used extensively to stimulate the production of hydrocarbons, water and other fluids from subterranean formations. These operations involve pumping a slurry of “proppant” (natural or synthetic materials that prop open a fracture after it is created) in hydraulic fracturing or “gravel” in gravel packing In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is typically to create a short, wide, highly conductive fracture, in order to bypass near-wellbore damage done in drilling and/or completion, to ensure good fluid communication between the rock and the wellbore and also to increase the surface area available for fluids to flow into the wellbore.

Also, the present method may be used to form a fluid for use as a drilling fluid, completion fluid, coiled tubing fluid, sand control fluid, cementing composition fluid, or any other fluid that is introduced into the subterranean formation primarily for the recovery of hydrocarbons. The fluid is introduced to the subterranean formation by drilling equipment, fracturing equipment, coiled tubing equipment, cementing equipment, or onshore or offshore water injectors. During, before, or after the fluid is added to a subterranean formation, the formation may benefit from fracturing, drilling, controlling sand, cementing, or injecting a well.

Enhanced Oil Recovery (EOR) or other water injector services may benefit from embodiments of this invention. As fluids are injected into the formation, long term prevention of bacterial growth may be desirable.

Slickwater fluids may also benefit from embodiments of this invention. The returned slickwater loads are very brackish and in certain cases are soured by H2S. Once biocides are used to kill in the surface mix water, inhibitor can be added to prevent bacterial growth, especially downhole.

Generally, embodiments of the invention relate to the use of inhibitors/biostats as an effective alternative or compliment to biocides for fracturing operations. That is, embodiments of this invention relate to the use of inhibitors for managing microbes in water used for fracturing.

It is recognized that some embodiments of this invention may not apply well to all injection services, e.g., Microbial EOR (MEOR). MEOR injects bacteria and nutrients into the reservoir where the bacteria multiply and release biosurfactants, with the type and amount dependent on both the specific strain of microbes and growth conditions. It is believed that the bio-surfactants cause a reduction in the oil-water interfacial tension (IFT). Furthermore, this reduction in interfacial tension may change the oil-rock contact, causing an altered wettability. Data supports the characterization of biosurfactants as interfacial tension reducers.

The following examples serve to further illustrate the invention.

### EXAMPLE

Produced water samples from the Piceancebasin were tested for bacterial content in a simple qualitative test kit manufactured by “Droycon Boiconcepts Inc., specific to Sulfate-Reducing Bacteria. Three kits were used, labeled “No treatment”, “Glutaraldehyde”, and “Glut+butenolide”. The latter two bottles were treated with 250 ppm glutaraldehyde. The “Glut+butenolide” sample had a further 125 ppm butenolide added.

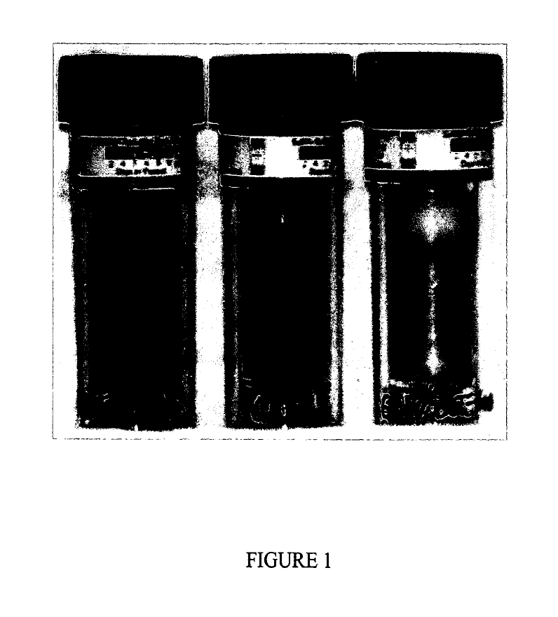

After 14 days, the “No treatment” sample showed black residues characteristic of the presence of SRBs, while the other two sample bottles were both clear and pale yellow. After 17 days, the “Glut+butenolide” bottle was still clear and pale yellow but the “Glutaraldehyde” bottle had begun to show re-growth of SRBs, as evidenced by the appearance in the previously clear solution of fine black residues. FIG. 1 is a photograph series that compares the experimental results of testing the effectiveness of biocide compositions.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

What is claimed is:

1. A method to prevent the proliferation of undesired life forms in a subterranean formation, comprising:
forming a fluid comprising an inhibitor; and
introducing the inhibitor to a surface in the formation.

2. The method of claim 1, wherein the inhibitor is a fully substituted butenolide.

3. The method of claim 1, wherein the fluid further comprises anthraquinone, nitrite, nitrate, selenate, molybdate, or tungstate ions or a combination thereof.

4. The method of claim 1, wherein the fluid further comprises a biocide.

5. The method of claim 4, wherein the biocide comprises aldehydes, quaternary phosphonium compounds, cationic polymers and alky-, di- and tri-amines, isothiazolones, thiones, phenolics, long chain quaternary ammonium compounds or a combination thereof.

6. The method of claim 1, wherein the fluid further comprises a surfactant.

7. The method of claim 6, wherein the surfactant comprises cationic, anionic, nonionic, or amphoteric surfactants or a combination thereof.

8. The method of claim 6, wherein the surfactant comprises alkyl amines, alcohol ethoxysulfate salt, tridecyl ether sulfate salt, ethoxylated alcohol, decyl-dimethyl amine oxide or a combination thereof.

9. The method of claim 1, wherein the fluid further comprises a surfactant, biocide, inhibitor, and an oxygen scavenger.

10. The method of claim 1, wherein the introducing comprises hydraulic fracturing.

11. A method to prevent the proliferation of undesired life forms along a surface of tubular or equipment for use in the oil field services industry, comprising:
forming a coating comprising an inhibitor; and
introducing the coating to a surface of the tubular or equipment.

12. The method of claim 11, wherein the inhibitor is a fully substituted butenolide.

13. The method of claim 11, wherein the fluid further comprises anthraquinone, nitrite, nitrate, selenate, molybdate, or tungstate ions or a combination thereof.

14. The method of claim 11, wherein the fluid further comprises a biocide.

15. The method of claim 14, wherein the biocide comprises aldehydes, quaternary phosphonium compounds, cationic polymers and alky-, di- and tri-amines, isothiazolones, thiones, phenolics, long chain quaternary ammonium compounds or a combination thereof.

16. The method of claim 11, wherein the fluid further comprises a surfactant.

17. The method of claim 16, wherein the surfactant comprises cationic, anionic, nonionic, or amphoteric surfactants or a combination thereof.

18. The method of claim 16, wherein the surfactant comprises alkyl amines, alcohol ethoxysulfate salt, tridecyl ether sulfate salt, ethoxylated alcohol, decyl-dimethyl amine oxide or a combination thereof.

19. The method of claim 11, wherein the fluid further comprises a surfactant, biocide, inhibitor, and an oxygen scavenger.

20. A method to prevent the proliferation of undesired life forms along a surface of tubular or equipment for use in the oil field services industry, comprising:
forming a material comprising an inhibitor; and
embedding the material into a surface of the tubular or equipment.
